(19) United States
(12) Patent Application Publication
(10) Pub. No.: US 2024/0348343 A1
(43) Pub. Date: Oct. 17, 2024

(54) Polarization-Diverse Radio Receive Element, Receiver, Transceiver and Related Methods of Operation

(71) Applicant: Phase Sensitive Innovations, Inc., Newark, DE (US)

(72) Inventors: Benjamin Mazur, Newark, DE (US); Timothy Creazzo, West Grove, PA (US); Janusz Murakowski, Bear, DE (US); Garrett Schneider, New Castle, DE (US); Shouyuan Shi, Newark, DE (US)

(21) Appl. No.: 18/633,351

(22) Filed: Apr. 11, 2024

Related U.S. Application Data
(60) Provisional application No. 63/458,512, filed on Apr. 11, 2023.

(51) Int. Cl. H04B 10/61; H04B 7/10; H04B 10/112

(52) U.S. Cl. CPC H04B 10/615; H04B 7/10; H04B 10/112

(57) ABSTRACT

An apparatus and methods for receiving polarization diverse radio signals. The apparatus includes a coherent light source configured to output an optical carrier signal, a dual polarization antenna, and a nested Mach-Zehnder Modulator. The nested Mach-Zehnder Modulator is configured to receive the optical carrier signal, a first RF electrical signal from a first output of a dual polarization antenna corresponding to a first linear polarization mode and a second RF electrical signal from a second output of the dual polarization antenna corresponding to a second linear polarization mode, modulate the optical carrier signal based on the first RF electrical signal and the second RF electrical signal to generate an upper optical sideband signal, a lower optical sideband signal, and output the upper and lower optical sideband signal separately.

### RELATED APPLICATIONS

This application is a non-provisional application of Provisional Application No. 63/458,512 filed Apr. 11, 2023, the entire contents of which are hereby incorporated by reference.

### TECHNICAL FIELD

This disclosure relates generally to radio frequency (RF) antennas, radio signals, digital signal processing, optical coherence, beamforming, and, in particular embodiments to receiving signals using phased array antennas.

### BACKGROUND

Many applications in wireless radio communications significantly benefit from using signals that are circularly polarized. In comparison with linearly polarized signals, circularly polarized signals have advantages in applications where the transmitter and receiver antennas may be rotated with respect to one another such that their linearly polarized antennas misalign, do not share a clear line-of-sight, or are operating in an environment in which the channel is impaired by multi-path or absorption. Satellite communications may establish RF links employing circular polarization since satellites may rotate with respect to one another and with respect to ground stations they may be communicating with. However, there are challenges associated with using circular polarization such as the need for complex antenna designs, complex waveguide geometries, RF phase shifters, RF hybrid couplers, and/or advanced digital signal processing. These requirements may add cost, size and weight, and fabrication difficulty; furthermore, they may limit the operational bandwidth of the RF system in which they are used. Additionally, an antenna optimized for receiving circularly polarized RF waves may not be suitable for receiving linearly polarized RF waves.

Elliptical polarization is the general case for electromagnetic wave polarization wherein two orthogonal linear components are summed to produce a resultant polarization vector. Linear polarization is the case of elliptical polarization where the orthogonal linear components may have different amplitudes but have no relative phase difference. Circular polarization is the case of elliptical polarization in which the orthogonal linear components have the same amplitude, however, their relative phase difference is 90-degrees+any integer multiple of 180-degrees. A circularly polarized wave could be left-hand (LH) polarized or right-hand (RH) polarized depending on whether the 90-degree phase shift between the orthogonal linear components is positive or negative. LH and RH are orthogonal polarization states.

### SUMMARY

According to some embodiments, an apparatus for receiving radio signals of diverse polarization includes a coherent light source, a dual polarization antenna, and a nested Mach-Zehnder Modulator. The coherent light source is configured to output an optical carrier signal. The dual polarization antenna configured to receive an RF signal and output a first RF electrical signal based on a first polarization mode of the RF signal and a second RF electrical signal based on a second polarization mode of the RF signal that is orthogonal to the first polarization mode. The nested Mach-Zehnder Modulator is configured to receive the optical carrier signal, the first RF electrical signal corresponding to a first polarization mode and the second RF electrical signal corresponding to a second polarization mode that is orthogonal to the first polarization mode, modulate the optical carrier signal based on the first RF electrical signal and the second RF electrical signal to generate an upper optical sideband signal, a lower optical sideband signal, and output the optical carrier signal, an upper sideband optical sideband signal, and the lower optical sideband signal, wherein the optical carrier signal, the lower optical sideband signal, and the upper optical sideband signal are output separately.

According to some embodiments, a method for receiving radio signals of diverse polarization includes receiving two orthogonal components of an RF signal, modulating an optical carrier signal to produce a first modulated light signal and a second modulated light signal, combining the first modulated light signal and the second modulated light signal to produce an upper sideband light signal and a lower sideband light signal, and outputting the upper and lower sideband light signals. The two orthogonal component of the RF signal have a 90-degree phase difference and are received directly from a dual-polarization antenna without any intervening RF phase shifters. The first modulated light signal corresponds to a first orthogonal component of the RF signal and the second modulated light signal corresponds to the second orthogonal component of the RF signal. Combining the first modulated light signal and the second modulated light signal produces an upper sideband light signal corresponding to the RF signal and a lower sideband light signal corresponding to the RF signal. The upper sideband light signal corresponding to the RF signal is output to a first port and the lower sideband light signal corresponding to the RF signal is output to a second port.

### BRIEF DESCRIPTION OF THE DRAWINGS

For a more complete understanding of this disclosure, and the advantages thereof, reference is now made to the following descriptions taken in conjunction with the accompanying drawings, in which:

FIG. 1 illustrates a schematic overview of a polarization-diverse receive element.

FIG. 2 illustrates a generic example of a Mach-Zehnder modulator.

FIG. 3 illustrates an example of a nested Mach-Zehnder modulator suitable for use with embodiments of a polarization diverse receive element.

FIG. 4 illustrates a high-level schematic of a nested Mach-Zehnder modulator.

FIG. 5 illustrates an example of an operational mode of a polarization diverse receive element.

FIG. 6 illustrates an example of an operational mode of a polarization diverse receive element.

FIG. 7 illustrates an example of an operational mode of a polarization diverse receive element.

FIG. 8 illustrates an example of an operational mode of a polarization diverse receive element.

FIG. 9 illustrates an example of an operational mode of a polarization diverse receive element.

FIG. 10 illustrates an example of an operational mode of a polarization diverse receive element.

FIG. 11 illustrates an example of an operational mode of a polarization diverse receive element.

FIG. 12 illustrates an example of a polarization diverse receive element with optical filters.

FIG. 13 illustrates an example of a polarization diverse receive element with an additional light signal.

FIG. 14 illustrates an example of a polarization-diverse receive array.

FIG. 15 illustrates an example of a polarization-diverse transceiver architecture.

FIG. 16 illustrates an example of a polarization-diverse transceiver architecture with photonic image rejection.

FIG. 17 illustrates an example of a polarization-diverse transceiver architecture with photonic image rejection.

FIG. 18 illustrates an example of a polarization-diverse receive element implemented electronically using an IQ mixer.

### DETAILED DESCRIPTION

The present disclosure now will be described more fully hereinafter with reference to the accompanying drawings, in which various exemplary implementations are shown. The invention may, however, be embodied in many different forms and should not be construed as limited to the exemplary implementations set forth herein. These example implementations are just that-examples-and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impractical to list every possible variation for every feature described herein. The language of the claims should be referenced in determining the requirements of the invention.

An apparatus comprising a coherent light source, a nested Mach-Zehnder modulator (NMZM), at least one dual-polarization antenna, a plurality of photodetectors, an optical processor, an optical local oscillator, filters, a digital processor, such as an FPGA (field-programmable gate array), phase modulators, electronic conditioning circuitry, and synchronization circuitry may be utilized to receive radio signal with many types of polarization using the same architecture and by only changing operational parameters. A single antenna may be used to receive radio signal having circular polarization and linear polarization.

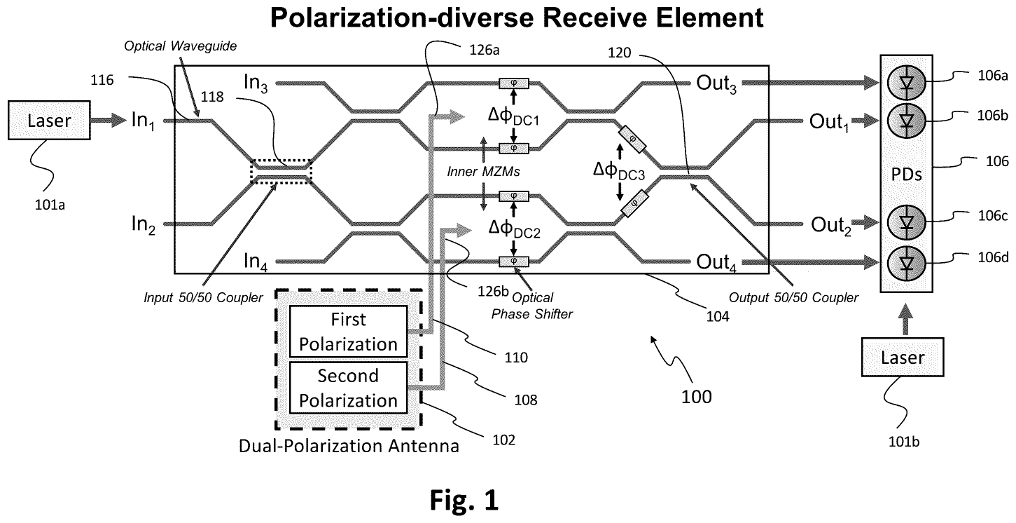

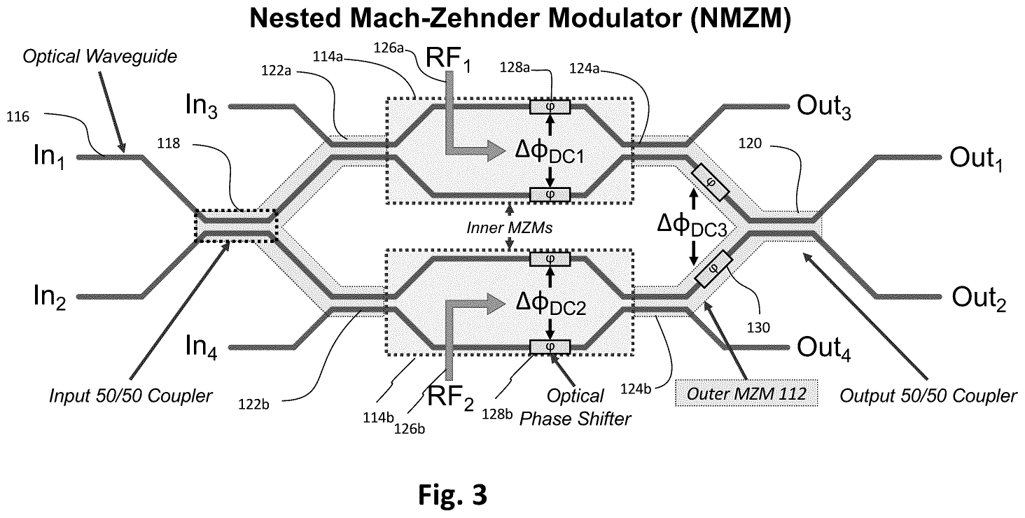

FIG. 1 illustrates an example of an embodiment of a polarization diverse radio receive element 100. The polarization diverse radio receive element 100 includes a primary and secondary lasers 101a and 101b, a first RF port 108 for receiving a first RF electrical signal, a second RF port 110 for receiving a second RF electrical signal, an NMZM 104 that will be described in more detail in relation to FIG. 3, and a plurality of photodetectors 106. A dual-polarization antenna 102, which may be external to the polarization diverse radio receive element 100, receives an RF electromagnetic wave and outputs RF electrical signals generated from the RF electromagnetic wave to the first RF port 108 and the second RF port 110. The RF electrical signals output to the first electrical port and the second electrical port correspond to two orthogonal components of the RF electromagnetic wave received by the dual-polarization antenna 102. The polarization diverse radio receive clement 100 receives the RF electrical signals from the dual-polarization antenna 102 and outputs RF electrical signals derived from the RF signal as will be explained below.

In some embodiments, the primary laser 101a may generate an optical carrier signal (e.g., an optical tone) having a first frequency. The secondary laser that generates a reference light signal having a second frequency offset by a set amount from the frequency of the optical carrier signal produced by the primary laser. The reference light signal of the secondary laser 101b acts as a local oscillator for a down-conversion process (further details described elsewhere herein) and may be also be referenced as “local oscillator” or LO. In addition, the optical carrier signal and the reference light signal may be phase-locked to each other. For example, a variation in phase in the optical carrier signal produced by the primary laser 101a may cause the same variation in phase in reference light signal of the secondary laser. The primary and secondary lasers 101a and 101b may be part of a tunable optical pair source (TOPS) such as disclosed in “Radiofrequency signal-generation system with over seven octaves of continuous tuning,” authored by Schneider et al., and published in Nature Photonics, online Jan. 20, 2013, and/or as disclosed in U.S. Pat. No. 10,965,100, issue Mar. 30, 2021, the contents of each of which is hereby incorporated by reference in its entirety. In some examples, the offset of the first frequency and second frequency may be set by an input to the optical source (e.g., TOPS) including the primary and secondary lasers 101a and 101b, such as by a user input (e.g., programmed).

As will be described in more detail, the optical carrier signal generated by the primary laser 101a is modulated by the NMZM 104 based on the RF electrical signals received at the first RF port 108 and the second RF port 110 to generate a plurality of optical output signals. The plurality of optical output signals may then be transmitted to the plurality of photodetectors 106. The plurality of optical output signals may be combined with the reference light signal of laser 101b to create a corresponding combined light signal having a corresponding RF (or intermediate frequency, IF) beat frequency (the optical representation of this RF beat frequency signal may be referred to herein as an RF beat frequency signal), each combined light signal being directed onto a corresponding one of the photodetectors 106 which in turn generates an RF electrical signal corresponding to the corresponding RF beat frequency signal (e.g., an RF electrical signal having an RF frequency of the RF beat frequency and containing all information of the RF beat frequency signal). Some or all of the optical output signals may be further processed in the optical realm before being converted into an RF electrical signal by the plurality of photodetectors 106.

The dual-polarization antenna 102 captures RF electromagnetic waves and converts the RF electromagnetic waves into RF or IF electrical signals. The dual-polarization antenna 102 is excited by two orthogonal polarization modes and has a first output corresponding to a first orthogonal polarization mode that is connected to the first RF port 108 of the polarization diverse radio receive clement 100 and a second output corresponding to a second orthogonal polarization mode that is connected to the second RF port 110 of the polarization diverse radio receive element 100. The first orthogonal polarization mode may be a vertical polarization mode and the second orthogonal polarization mode may be a horizontal polarization mode, but embodiments are not limited thereto. In some embodiments, the first orthogonal polarization mode may be a right-handed circular polarization and the second orthogonal polarization mode may be a left-handed circular polarization. A linearly polarized RF wave may be represented as a combination of a right-handed circular polarized RF wave and a left-handed circular polarized RF wave. Thus, a dual polarization having orthogonal circularly polarized receiving elements may be used to receive a linearly polarized wave.

Receiving circularly polarized RF wave with a dual-polarization antenna, where the RF signals carried by the RF ports 108 and 110 correspond to linearly polarized orthogonal modes, in combination with NMZM 104 may be advantageous in that it introduces a 90-degree phase shift between the RF signals that can be used to remove an upper or lower sideband from an output without the use of a conventional RF phase shifter. In some examples, the dual-polarization antenna 102 may include first and second monopole elements or first and second dipole elements, where the radiating arms of such antennas are arranged to be perpendicular to one another.

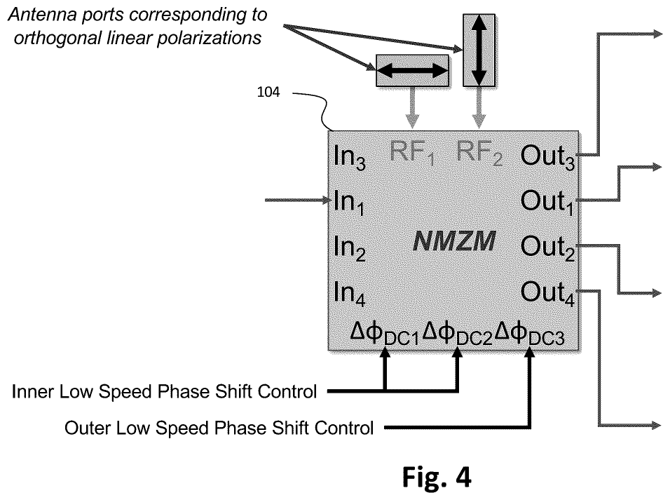

The NMZM 104 of FIGS. 1 and 3 has four optical outputs that each output an output light signal which may each be converted into an RF electrical signal by a photodetector of the plurality of photodetectors 106. The output light signals may each be the optical carrier signal, a sideband light signal, or a combination thereof depending on the settings of the NMZM 104 and the polarization of the RF electromagnetic wave received by the dual-polarization antenna 102. This will be described in more detail in relation to FIGS. 4-10. Each output light signal may be transmitted to a corresponding one of the plurality of photodetectors 106. For example, an NMZM 104 with four optical outputs may have a first photodetector 106a, a second photodetector 106b, a third photodetector 106c, and a fourth photodetector 106d. Each photodetector may output an RF or IF electrical signal corresponding to one of the output light signals. It should be appreciated that not all of the described output light signals need be generated by the NMZM 104 and/or converted to a corresponding RF electrical signal. For example, in some embodiments, optical carrier signals may not be output and/or converted into a corresponding RF electrical signal.

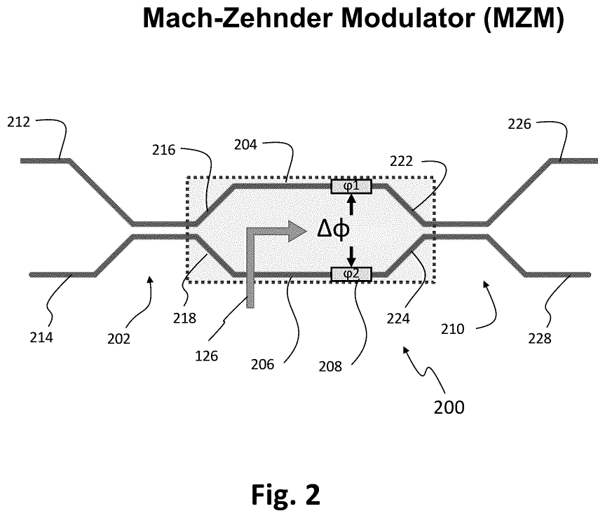

FIG. 2 illustrates an example of a Mach-Zehnder modulator (MZM) 200. The MZM 200 has an optical path including an input optical coupler 202, a first internal wave guide 204, a second internal waveguide 206 in parallel with the first internal wave guide 204, an optical phase shifter 208, and an output optical coupler 210. The MZM 200 further includes an RF port 126 for receiving an RF electrical signal for modulating light travelling through the MZM 200. Each component in the optical path of the MZM 200 is connected by an optical transmission medium such as an optical waveguide.

The optical couplers may each be an X coupler (2×2) that includes two light inputs and two light outputs. An X coupler (2×2) combines light signals provided at the two inputs and splits the combined light signal into a first combined light signal at a first output and a second combined light signal at a second output. Each light signal at the outputs may be identical to one another, with the exception that the X coupler introduces a quarter wavelength relative phase shift between the light at the two inputs. For example, the light signal at the second output has a component of the light signal at the first light input and a component of the light signal at the second light input with the component of the first light input being phase shifted by 90 degrees relative to a component of the light signal at the second input and the light signal at the first output has a component of the light signal at the first light input and a component of the light signal at the second input that is phase shifted by 90 degrees relative to the component of the light signal at the first input. The X coupler (2×2) may function as a combiner for the two light inputs and a splitter for the two light outputs. A single light signal may be split into two light signals by feeding a single light input of the X coupler (2×2) resulting in two light signals, with one having a 90-degree phase shift relative to the other. Two light signals may be combined by feeding each light input with a different light signal and obtaining a combined light signal output at one or both of the light outputs. The combined light signal will have a component of one of the light signals phase shifted 90 degrees relative to the component of the other light signa being combined. Other embodiments may use other types of optical couplers.

The input optical coupler 202 combines light signals feeding the input optical coupler 202 and separates the resulting combined light signal into a plurality of light outputs. Each light signal output from an output of the plurality of light outputs may be identical to one another aside from a phase shift as explained previously. The input optical coupler 202 in MZM 200 of FIG. 2 has a first light input 212, a second light input 214, a first light output 216, and a second light output 218. A first light signal entering the first light input 212 combines with a second light signal entering the second light input 214 to generate a combined light signal that is split between a first combined light signal output at the first light output 216 and a second combined light signal output at the second light output 218. The first combined light signal includes a component of the first light signal and a component of the second light signal phase shifted 90 degrees. The second combined light signal includes a component of the second light signal and a component of the first light signal phase shifted 90 degrees.

The first light output 216 feeds the first combined light signal to the first internal waveguide and the second light output 218 feeds the second combined light signal to the second internal waveguide 206. The internal waveguides are formed of a material with a strong electro-optic effect (such as LiNbO3, GaAs, InP). Applying an electric field to the material changes its index of refraction which changes its optical path length and results in phase modulation of a light signal travelling through the internal waveguide. Because the amplitude of the radio signal input at the RF port 126 varies, the strength of the electric field in the internal wave guide varies and the amount of phase change of the light signal varies dependent on the strength of the RF electric signal resulting in a phase modulated light signal.

When the phase modulation results in a relative phase difference between the first light signal and the second light signal, the phase modulated light signal can be converted to an amplitude modulated light signal by combining the two light signals. If a single one of the light signals is modulated, combining the two light signals results in an amplitude modulated light signal. If both light signals are modulated, one of the light signals can be modulated inversely in a push-pull arrangement such that when the light signals are combined the result is an amplitude modulated light signal.

The optical phase shifter further shifts the relative phase of the light travelling through the internal optical waveguide. The optical phase shifter may be applied to one or both of the first internal optical waveguide and the second internal optical waveguide to cause a fixed relative phase shift between the first light signal and the second light signal that may be independent of the phase shift caused by the modulation. The amount of relative phase shift between the two combined light signals can steer the unmodulated component of the light signal to a particular output light port as will be explained.

The MZM 200 has an output optical coupler 210 that may function the same as the input optical coupler 202. The output optical coupler 210 includes a first light input 222, a second light input 224, a first light output 226, and a second light output 228. The first light input 222 is connected to the first internal wave guide 204 and second light input is connected to the second internal waveguide 206. The first combined light signal and the second combined light signal, with at least one of the combined light signals modulated with the RF electric signal, are combined into a third combined light signal and a fourth combined light signal that are output at the first light output 226 and the second light output 228, respectively. The relative phase difference between the first combined light signal and the second combined light signal controls which port the unmodulated component of the combined light will exit. When the phase shift is set to null (the amount of phase shift being measured by the amplitude of the unmodulated first light signal being output at the second light output 228), i.e., the MZM is null-biased, the unmodulated component of the first light signal in the first combined light signal and the unmodulated component of the first light signal in the second combined light signal experience destructive interference at the second light output 228 and constructive interference at the first light output 226 so that the unmodulated component is steered to the first light output 226. In a similar manner, the unmodulated component of the second light source is steered to the second light output 228. When the phase shift is sent to peak, i.e., the MZM is peak-biased, the opposite occurs and the two unmodulated component switch between the first light output 226 and the second light output 228.

FIG. 3 illustrates an example of a NMZM 104 according to some embodiments. The NMZM 104 may be conceptualized as an outer MZM having an inner MZM 114 on each leg of the outer MZM 112. For example, referring to the MZM 200 of FIG. 2, an input optical waveguide 116 may correspond to the first light input 212 of the outer MZM 112, an input optical coupler 118 may correspond to the input optical coupler 202 of the outer MZM 112, a first inner input optical coupler 122a may correspond to the input optical coupler 202 of the first inner MZM 114a, a first inner output coupler 124a may correspond to the output optical coupler 210 of the first inner MZM 114a, a second inner input optical coupler 122b may correspond to the input optical coupler 202 of the second inner MZM 114b, a second inner output coupler 124b may correspond to the output optical coupler 210 of the second inner MZM 114b, and an output optical coupler 120 may correspond to an output optical coupler 210 of the outer MZM 112.

The operation of the NMZM 104 will now be described with reference to FIG. 3. The input optical waveguide 116 transfers a light signal to the input optical coupler 118. The input optical coupler 118 splits the light into two new light signals having the same frequency, but at a reduced amplitude and 90 degrees out of phase. The two new light signals may be identical or substantially identical to one another. Each of the two new light signals then exit the input optical coupler 118 through a respective light output of the input optical coupler 118.

Each light output of the input optical coupler 118 feeds a respective inner MZM 114. Each light output by the input optical coupler 118 may feed the respective inner MZM 114 by way of a waveguide connected between a respective light output and a light input of the respective inner MZM 114. Each light input of the inner MZM 114 feeds an inner input optical coupler 122 which may function the same as the input optical coupler 118 to split an incoming light signal into two new light signals that are 90 degrees out of phase. Thus, a single light signal entering the NMZM 104 may be split into four new light signals that are substantially the same as one another except for the relative phase with two new light signals directed to first inner MZM 114a and two new light signals that are 90 degrees out of phase directed to the second inner MZM 114b. Each of the new light signals is fed to an arm of an inner MZM 114 such that each inner MZM 114 is fed two identical light signals, one at each arm with one being 90 degrees out of phase relative to the other one.

Each of the inner MZMs 114 has an RF port 126 for receiving an RF electrical signal. The RF electrical signal generates an electric field in an internal waveguide of the inner MZM 114 that is dependent on the RF electrical signal. Because the internal waveguide of the inner MZM 114 has a refractive index that varies with the electric field, the phase of a light signal travelling through the internal waveguide is shifted dependent on the strength of the electric field when it is output from the internal waveguide. This results in the phase of the light signal being phase modulated by the RF electrical signal. The light signal may be modulated in both legs of an inner MZM 114 with the electric field of one of the legs being inverted such that a relative phase shift occurs between both modulated light signals in a push-pull fashion.

The RF phase modulation in each leg of the inner MZM 114 manifests in frequency domain as modulation sidebands flanking the optical carrier. In small-signal regime, where the amplitude of the modulating signal is much smaller than the half-wave voltage of the modulator, the phase modulation may generate significantly only a pair of sidebands: one upper sideband and one lower sideband. The difference in frequency between the optical carrier and the modulation sideband equals the frequency of the modulating RF signal. A broadband modulating RF signal yields correspondingly broadband modulation sidebands in the optical domain.

In addition to the rapidly varying in time phase shift caused by the electric field generated by the RF electrical signal, each leg of the inner MZM 114 may have an additional optical phase shifter for shifting the phase of a light signal travelling through a leg independent of the RF electrical signal. For example, a bias voltage may generate an additional electric field applied to the inner waveguide of a leg of the inner MZM 114 to further shift the relative phase of the light signal in the inner wave guide.

Each leg of the inner MZM 114 outputs the light signal travelling through the leg into an inner output coupler 124 that combines the two light signals from the two legs of the inner MZM 114. Since the two light signals have experienced a relative phase shift that is dependent on the RF electrical signal, they may interfere with one another when combined. The interference may be constructive or destructive depending on the amount of relative phase shift. For example, if one light signal has shifted 180 degrees relative to the other light signal they will interfere destructively. If the light signals have little relative phase shift, they may interfere constructively.

The light signal output by each light output of an inner MZM 114 may be adjusted using the additional optical phase shifters to adjust the relative phase shift of the light signal in each leg of the inner MZM 114. For example, when the optical phase shifter is set to null, the components of the unmodulated light, i.e., the optical carrier, will be out of phase between the legs at one of the light outputs of the inner output coupler 124 and the unmodulated light signal will not be output there. At the other output, the unmodulated light will be in phase and at a maximum and the unmodulated light signal will be output there.

An outer optical phase shifter 130 may adjust the relative phase of each first light output of the inner MZMs 114. The phase adjustment may be used to steer a sideband to a particular light output. For example, if the relative phase is adjusted to quadrature (90 degrees) the light output of one of the upper or lower sideband may be maximized at a first light output and minimized at a second light output and the other of the upper or lower sideband may be minimized at the first output and maximized at the second light output. Which sideband is steered to a given port may be dependent on the polarization of the original RF signal, but the upper and lower sidebands may be separated without using an RF phase shifter.

With reference to FIGS. 1, 2 and 3, the operation of the polarization-diverse radio receive element will be described. A light signal from a primary laser 101a (i.e., a coherent light source), which will hereafter be referred to as an optical carrier signal, enters the NMZM 104 through the input optical waveguide 116 and feeds the input optical coupler 118 where the optical carrier signal is evenly divided between the two outputs of the input optical coupler 118. While another optical input waveguide In2 is shown in FIGS. 1 and 2, it may not be used and may be disconnected such that no input is received at the other optical input waveguide In2. Alternatively, a Y splitter with a single input may be used in place of the input optical coupler 118. However, the use of a Y splitter may alter the adjustment points of the phase shifters to obtain the desired output configuration as compared to the coupler 118.

The input optical coupler 118 splits the optical carrier signal into a first optical carrier signal and a second optical carrier signal as described previously. Each of the first and second optical carrier signals enter a respective inner input optical coupler 122 at the input of a respective inner MZM 114. For example, the first optical carrier signal output by the input optical coupler 118 may feed the first inner input optical coupler 122a and the second optical carrier signal may feed the second inner input optical coupler 122b. Each of the first and second optical carrier signals is divided again between the two arms of a respective one of the inner MZM 114. The respective one of the inner MZM 114 modulates the respective carrier signal in at least one of the arms based on an RF electrical signal received by the respective one of the inner MZM 114.

For example, the first optical carrier signal may be split into two internal light signals, one for each arm of the first inner MZM 114a, and the second optical carrier signal may be split into two internal light signals, one for each arm of the second inner MZM 114b. The first inner MZM 114a may modulate a first internal light signal in a first arm based on a first RF signal which may be an RF signal from a first port of the dual-polarization antenna and a second internal optical signal in the second arm may be modulated with the opposite of the RF signal from the first port in a push-pull configuration. The second inner MZM 114b may modulate a third internal light signal in a first arm based on a second RF signal, which may be from the second port of the dual-polarization antenna that is orthogonal to the first port and a fourth light signal in a second arm may be modulated in a push-pull configuration. The resulting light signals produced by RF modulation include components of the original optical carrier signal and additional optical signals representing the data contained in the RF signals which are referred to as sidebands, where each sideband is further referred to as an upper (USB) sideband if the sideband is higher in frequency than the optical carrier or a lower (LSB) sideband if the sideband is lower in frequency than the optical carrier. The two sidebands may be at a frequency that offset from the optical carrier in a positive and negative amount. Each inner MZM 114 outputs two light signals which may include components of the original optical carrier signal, components of the sidebands, or a combination depending on the settings of the optical phase shifters and whether one or both arms of the MZM are modulated.

In each of the inner MZM 114 a low-speed optical phase shifter controls a phase difference between the light signal in each of the arms of the inner MZM 114 (denoted in FIG. 2 as Δ_{φ}DC1 and Δ_{φ}DC2). Each inner MZM 114 can thereby bias the interference of the internal light signal at the output of the respective one of the inner MZM 114. By controlling the bias, each of the inner MZM 114 is biased to route either the sidebands or the carrier to a first output port and the other of the sidebands or carrier signal to a second output port. A first light signal which may correspond to the sidebands may be output from each of the inner MZM 114 to a corresponding arm of the outer MZM 112. A second light signal, which may correspond to the optical carrier signal, may bypass the outer MZM and be output directly from the inner MZM 114 as Out₃ and Out₄ in FIGS. 1 and 3.

The relative phase between the two first light signals (one for each of the inner MZM 114) may be controlled in the outer MZM with an outer optical phase shifter 130 (indicated as Δ_{φ}DC3).

Each light signal output from the NMZM 104, each of which may contain the carrier light signal or a sideband light signal, may be converted to an electrical signal by a respective photodetector of the plurality of photodetectors. Once converted to an electrical signal, the signals may be processed by electronic hardware to recover the desired information. The electronic components not shown in the diagram may also include balanced antenna feeds, amplifiers, and RF phase shifters for phase-error correction.

FIG. 4 illustrates a high-level block diagram of an NMZM 104 and will be used to describe operational modes according to embodiments of the invention. The NMZM 104 includes four input ports labeled as In1, In2, In3, and In4, four output ports labeled as Out1, Out2, Out3, and Out4, two RF input ports labeled as RF1 and RF2, and three inputs for controlling the low-speed phase shifters labeled as ΔφDC1, ΔφDC2, and ΔφDC3. The optical carrier signal may be input to a first input In1 and the remaining inputs In2, In3, and In4 may not be used. The output ports of the NMZM 104 output light signals that may correspond to a sideband, the carrier signal, or a combination thereof depending on the polarization of the received RF signal and the settings of the inner low speed phase shift control and the outer low speed phase shift control. Two of the output ports are the outputs of the outer MZM and the other two are the direct outputs of each of the inner MZM 114. These outputs will be described in greater detail in relation to FIGS. 4-10.

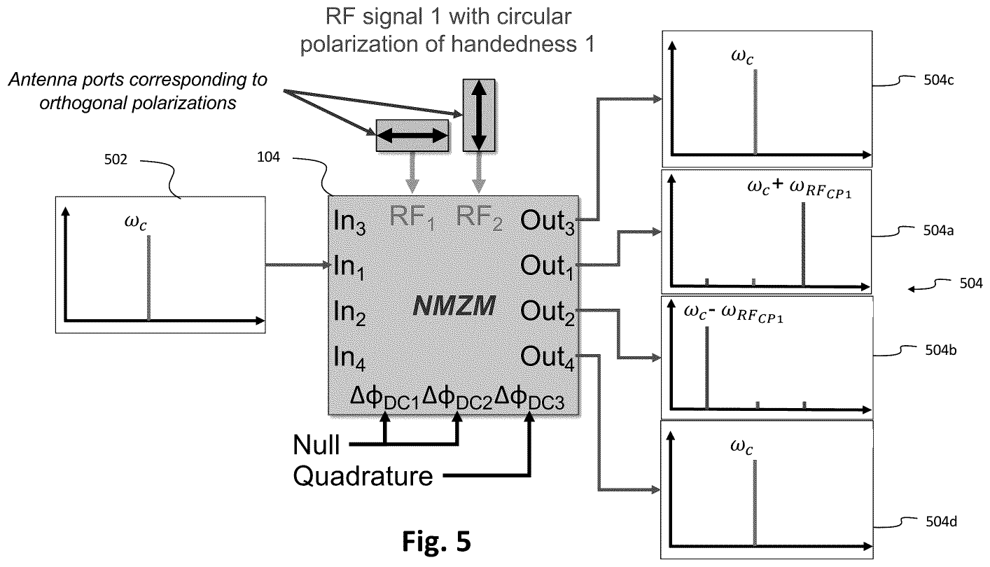

FIGS. 5-11 illustrate several operational modes according to embodiments of the invention. The operational modes will be described with reference to the example NMZM 104 of FIG. 4. Each of the figures illustrates an example output at each port for various settings of the low speed phase shift controls and the polarization of received RF signals.

FIG. 5 illustrates the input spectra 502 and output spectra 504 of the polarization diverse radio receive element 100 of FIG. 1 when the dual-polarization antenna 102 receives an RF wave with frequency ω_{RFCP1} and that is circularly polarized with a handedness of 1 (e.g., clockwise). The dual-polarization antenna 102 captures two orthogonal components of the radio wave and outputs corresponding electrical signals to RF ports of the NMZM 104 (i.e., first RF port 108 and second RF port 110) corresponding to the respective orthogonal components of the incoming wave's polarization. These two electrical signals, which may be equal in amplitude but differ in phase by 90 degrees, drive the RF₁ and RF₂ modulation ports of the NMZM. A single-tone optical carrier feeds In of the NMZM. For example, the primary laser 101a may feed In₁. When configured such that the inner MZM optical phase shifters (Δϕ_{DC1} and Δϕ_{DC2}) are each biased to null, thereby minimizing the optical carrier signal at Out₁ and Out₂, the two output ports of the outer MZM carry the modulation sidebands with one of the upper sidebands being output at one of Out₁ and Out₂ and the lower sideband being output at the other of Out₁ and Out₂. The outer MZM (Δϕ_{DC3}) is biased to quadrature (90-degree phase shift between the two arms of the outer MZM) so that the modulation sidebands of each orthogonal component of the radio wave interfere constructively in one of the light outputs and destructively in the other of the light outputs. Thus, the two output ports from the outer MZM, Out₁ and Out₂, will carry the USB and LSB respectively, while suppressing the carrier and other respective sideband (i.e., Out₁ will output the USB with suppressed LSB as shown in output spectra 504a, Out₂ will output the LSB with suppressed USB as shown in output spectra 504b, and the optical carrier is suppressed in both outputs Out₁ and Out₂). At the same time, the optical carrier will appear at the outputs of the inner MZMs, i.e., Out₃ and Out₄, as shown in output spectra 504c, 504d.

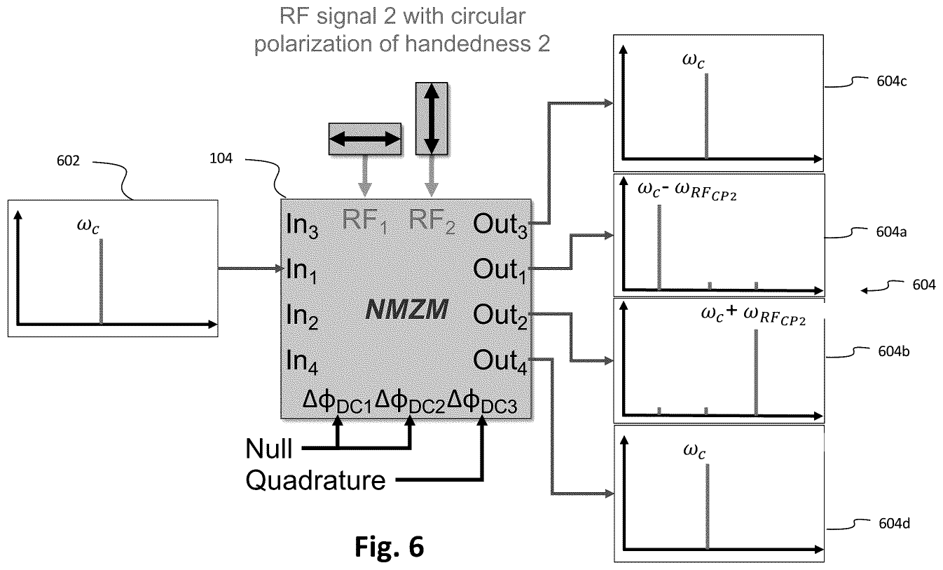

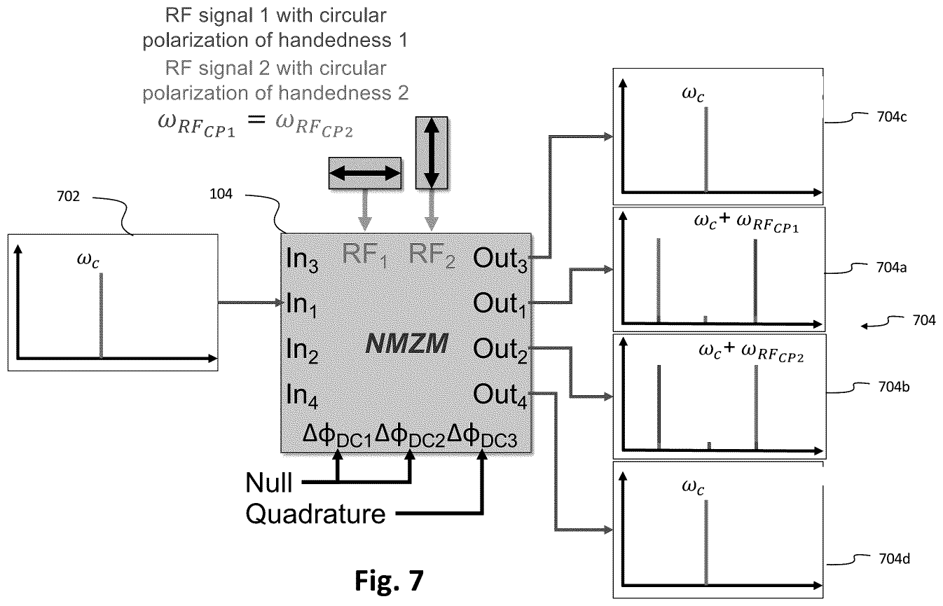

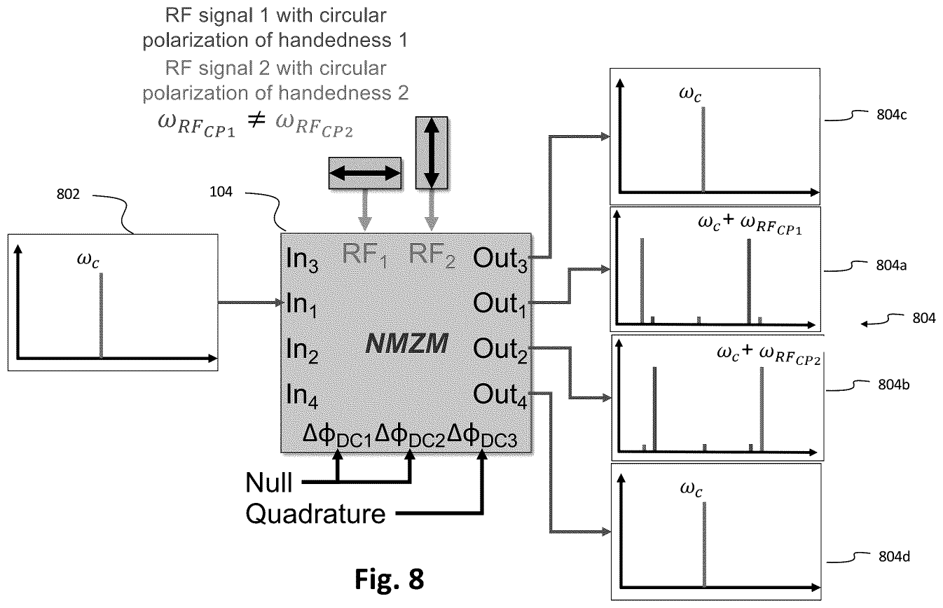

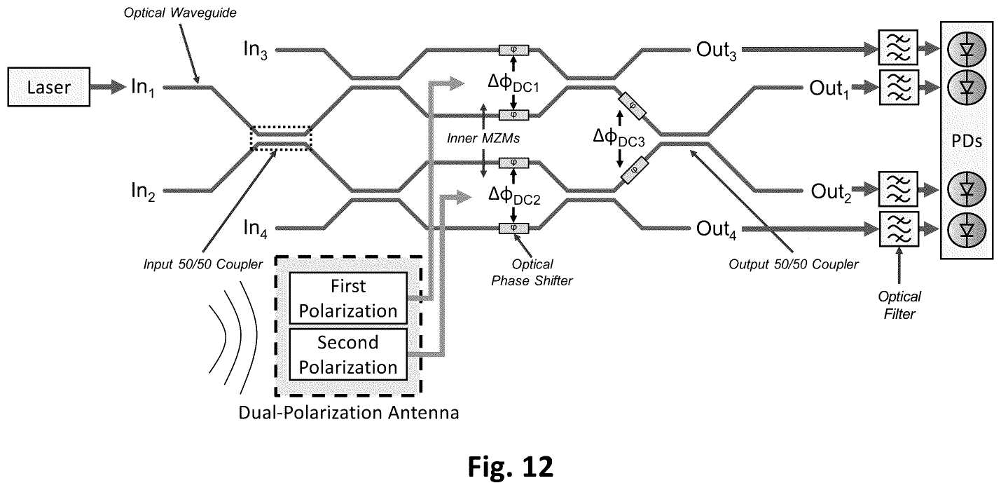

Illustrated in FIG. 6 is the situation where the received radio wave has frequency ω_{RFCP2} and is circularly polarized with handedness 2 (e.g., counterclockwise). With the same operational parameters as in the example in FIG. 3, i.e., the same biasing of inner and outer MZMs, the change in circular polarization handedness from clockwise to counterclockwise results in Out₁ outputting the LSB with suppressed USB as shown in spectra 604a, Out₂ outputting the USB with suppressed LSB as shown in spectra 604b, and a suppressed optical carrier in both outputs. Moreover, as illustrated in FIGS. 7 and 8, when simultaneously receiving two circularly polarized radio waves with opposite handedness (whether they share the same frequency or not) NMZM output Out₁ will carry the information from signal 1 in the USB as shown and information from signal 2 in the LSB as shown in spectra 704a and 804a, while Out₂ will carry the information from signal 2 in the USB and information from signal 1 in the LSB as shown in spectra 704b and 804b. To recover data from both circularly polarized signals simultaneously, optical filters may be included after the NMZM outputs, as shown in FIG. 12, to select the desired signal.

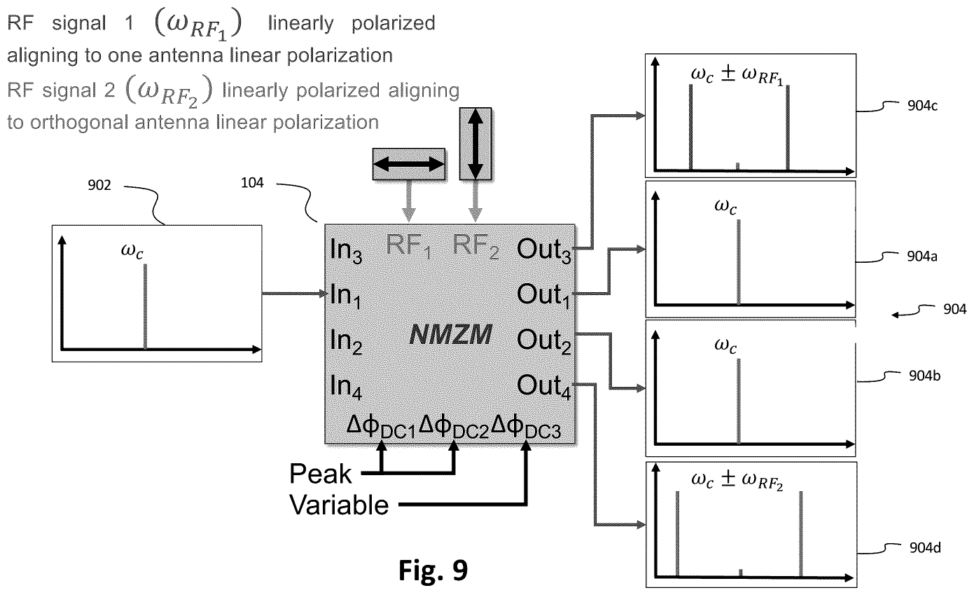

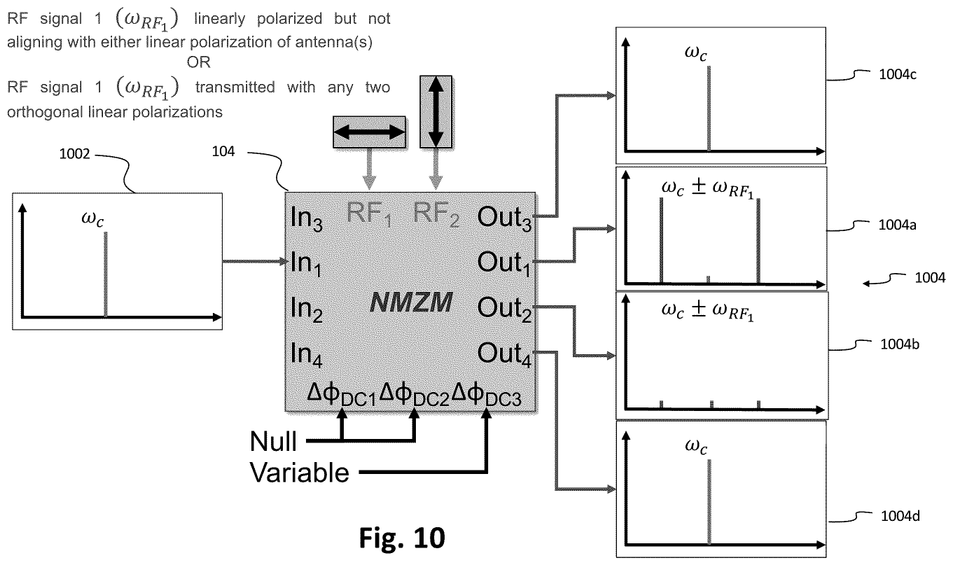

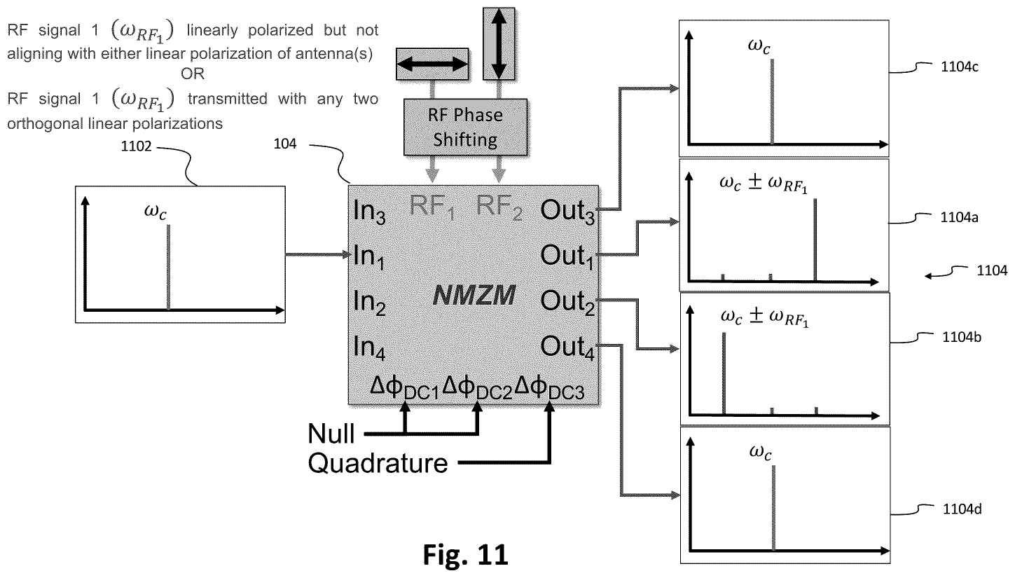

In addition to circular polarization, the Polarization-Diverse Radio Receive Element can also receive various forms of linear polarization. FIG. 9 illustrates an example where two RF signals with orthogonal linear polarization states are incident upon the dual-polarization antenna 102. RF signal 1 has a polarization that aligns with one polarization mode of the dual-polarization antenna, and RF signal 2 has a polarization aligning with the other polarization mode of the antenna. When configured such that the inner MZM optical phase shifters (Δϕ_{DC1} and Δϕ_{DC2}) are biased to “peak,” maximizing the optical carrier at Out₁ and Out₂, the output ports Out₃ and Out₄ carry the modulation sidebands with suppressed carrier as shown in spectra 904a. The carrier can be routed to Out₁, Out₂ or both by adjusting Δϕ_{DC3}. FIG. 10 depicts the scenario in which the antenna is receiving a radio wave with arbitrary linear polarization, and as such its ports output the incoming signal's orthogonal linear components. When the inner MZMs are biased to null, the antenna outputs may produce sidebands that sum coherently to Out₁ or Out₂, or to both, depending on the bias adjustment of the outer MZM (Δϕ_{DC3}) as shown in spectra 1004 and spectra 1004b. FIG. 11 depicts this same scenario except with a variation that includes RF phase shifters before the NMZM 104 that are tuned to create a 90-degree phase difference between the linear orthogonal components of the incoming RF signal. Due to this phase difference, the modulation sidebands may sum such that the USB would route to Out₁ and the LSB would route to Out₂, yielding single-sideband suppressed-carrier outputs as shown in spectra 1104a and spectra 1104b.

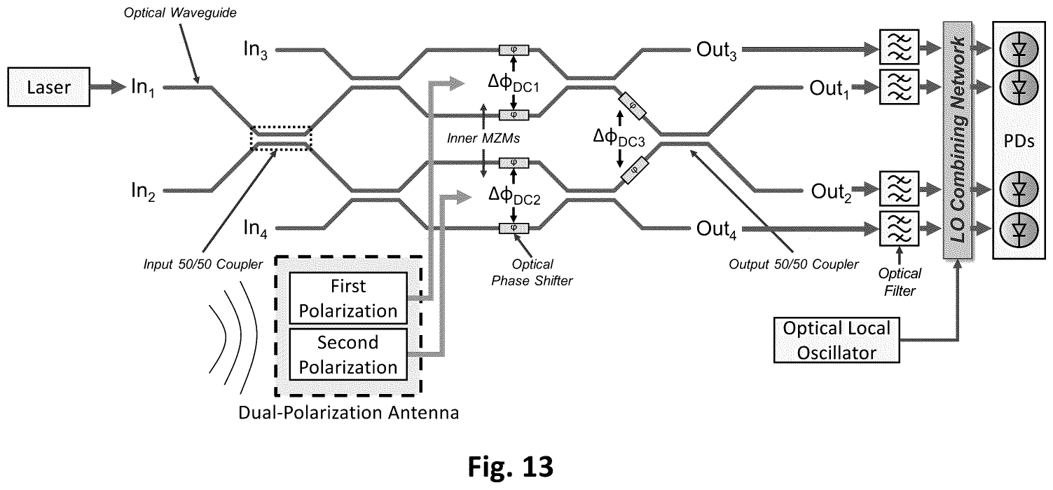

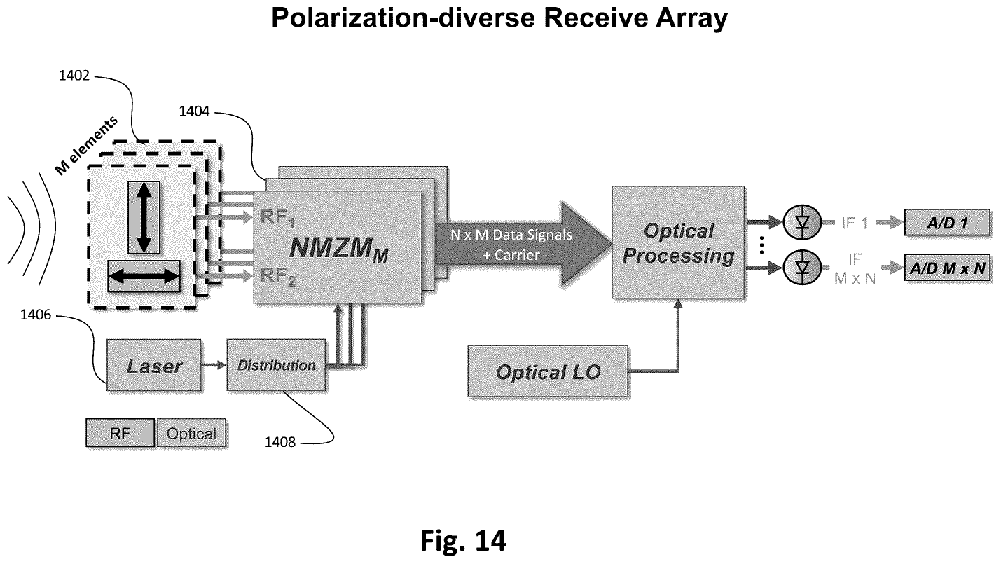

There are numerous potential variations on the architecture and components of this invention without departing from its spirit. For example, instead of a single dual-polarization antenna, multiple dual-polarization antennas could be used in an array. FIG. 14 depicts an embodiment in which a plurality of orthogonal linearly polarized antennas are arranged in an array. A plurality of dual-polarization antennas 1402 feed a plurality of NMZM 1404 such that each dual-polarization antenna 1402 feeds a respective NMZM 1404. A single laser 1406 may be used to produce the optical carrier for each of the plurality of NMZM 1404. The optical carrier produced by the single laser 1406 may be split in a distribution network 1408 to feed the optical carrier to each of the plurality of NMZM 1404. The optical output of the plurality of NMZM 1404 be input into an optical processing unit for processing prior to conversion to an RF electrical signal. The antenna could provide balanced or unbalanced outputs. The RF signals could be amplified before driving the NMZM. RF phase shifters could be included before the NMZM for phase-error compensation in any component or part of the electrical feed network. The NMZM substrate could be lithium niobate, silicon, silicon nitride, indium phosphide, or a combination of these. The 50/50 splitters and couplers could be implemented as directional couplers or multimode interference (MMI) splitters/couplers. Some of the 50/50 splitters or couplers could be implemented as Y-branch splitters/couplers. The inner MZMs may be single-drive or push-pull electro-optic modulators and may have travelling wave electrodes or plasmonic structures. The low-speed optical phase shifters may be thermo-optic, electrooptic, or carrier-injection based. Additional optical switching may be added before the NMZM and inside of each inner MZM to compensate for split-ratio imbalance in the 50/50 splitters and couplers. Optical taps and monitor photodetectors may be included for control and calibration. Optical filters may be added after the NMZM outputs (as shown in FIG. 12), and these filters may be fixed or tunable. There may be optical fibers between the NMZM outputs and the photodetectors so that the light signals may be sent to a remote location before converting to electrical signals. The photodetectors may be balanced photodetectors with any necessary amplitude and time-delay balancing within or after the combining network. As shown in FIG. 13, an additional light signal, for example an optical local oscillator (LO), may be included to heterodyne with any sideband to produce an electrical intermediate frequency (IF) containing the desired information. In this case, the filters may be omitted from the heterodyne configuration. Additionally, there may be electrical amplification or filtering after the photodetectors.

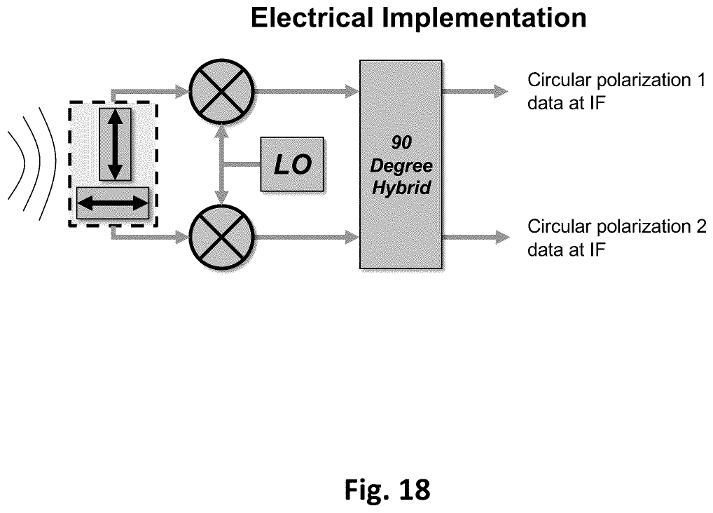

Embodiments of the invention disclosed here may also be implemented electronically using an IQ mixer, as illustrated in FIG. 18. In this case, the design is simplified to remove the need for an additional 90-degree hybrid typically present in direct-conversion receivers. The same polarization demultiplexing function may be performed by an IQ mixer driven with orthogonal linear components of circularly polarized waves. In this case, the outputs of the 90-degree hybrid will each contain data from the respective orthogonal circularly polarized RF signal, as indicated in FIG. 18. This purely-electronic approach may omit any optical components.

Furthermore, this receive element may be part of a larger system such as a radio receive array, part of a transceiver, or part of a transceiver array. In the case of a radio receive array (an example schematic is shown in FIG. 14), many receive elements may form a phased array receive aperture. In this case, the outputs from the NMZM may feed an optical processing stage before the light signals are converted to electrical signals by photodetectors and digitized by analog-to-digital converters (A/D). This optical processing could include filtering, as well as beam space processing. Furthermore, the receive array may include an optical LO, as illustrated in FIG. 13, that may enable optical down-conversion of the optical sideband signals to an electrical IF. Examples of such optical processing and extraction of electrical signals (including various options and implementations for optical filtering, use and introduction of an optical LO (or optical reference), beam space processing, image rejection, sensors/pickups and/or down-conversion) may be found in U.S. Pat. No. 9,525,489, filed Dec. 20, 2016, U.S. Patent Pub. No. 2021/0257729 (of U.S. application Ser. No. 17/160,676, filed Jan. 28, 2021), U.S. patent application Ser. No, 17/703,916, filed Mar. 24, 2022, and U.S. patent application Ser. No. 17/894,072, filed Aug. 23, 2022, each of which are hereby incorporated by reference in their entirety. This LO may be omitted in other configurations, for example in a passive RF imaging system.

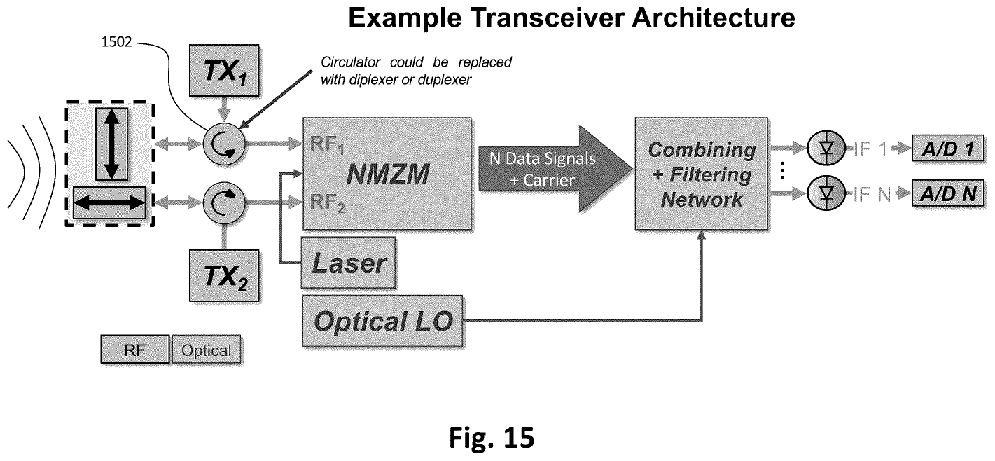

The polarization diverse receive element may be implemented as the receive portion of a radio transceiver (a combination of transmitter and receiver), such as depicted in FIG. 15, where the transmitted signals (TX₁ and TX₂) and the received signals share an antenna interface through the use of an RF circulator 1502. The purpose of the RF circulator 1502 is to route the signals from the transmit port to the antenna and received signals from the antenna to the receive port with maximum isolation between the transmit and receive ports. In shared interface full-duplex transceivers, a major challenge is the transmitted signal leaking and interfering with the received signal. If the transmitter were to use one handedness of circular polarization, with the receiver using the other handedness, the transmitted signal would be rejected in the receive path by the demultiplexing ability of the receive element, potentially enabling the usage of the transmitter and the receiver simultaneously on the same frequency. In this case, the receiver would get the transmitter rejection benefits of the circulator plus the rejection from the nested MZM device. Furthermore, because the receiver is only interested in one data signal with a designated circular polarization, the unused output port of the receive element may carry information from the unwanted polarization (and thus the transmitter signal) that may be measured and used for calibration, tracking purposes, and/or subtracted from the received signal to get further rejection of the transmitter signal. In a half-duplex mode of operation (where the transmitter and receiver do not operate at the same time), two circularly polarized signals (LH and RH) with different encoded data could be demultiplexed to double the available data-rate of the link. The circulator could be replaced with an electrical duplexer. If the transmitter and receiver use different frequencies, the circulator may be replaced with a diplexer, which isolates the transmitter from the receiver by employing spectral filtering.

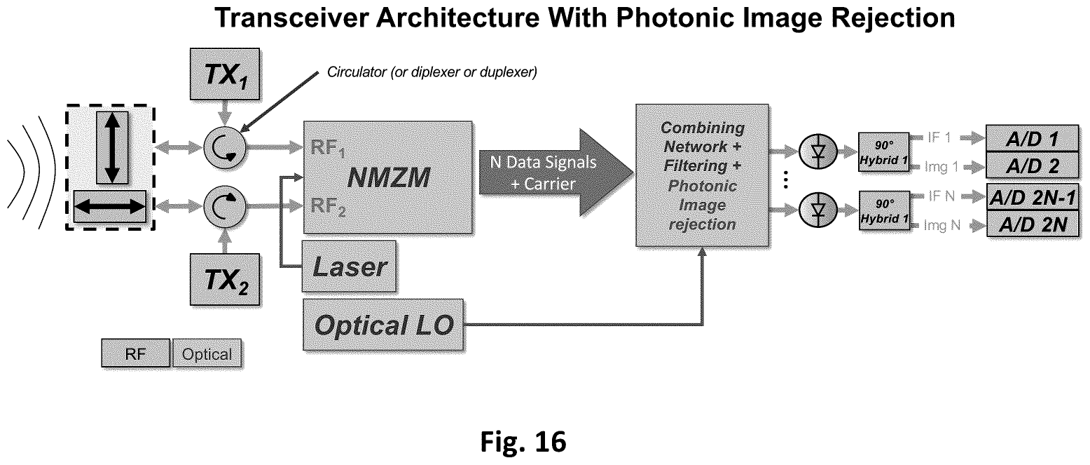

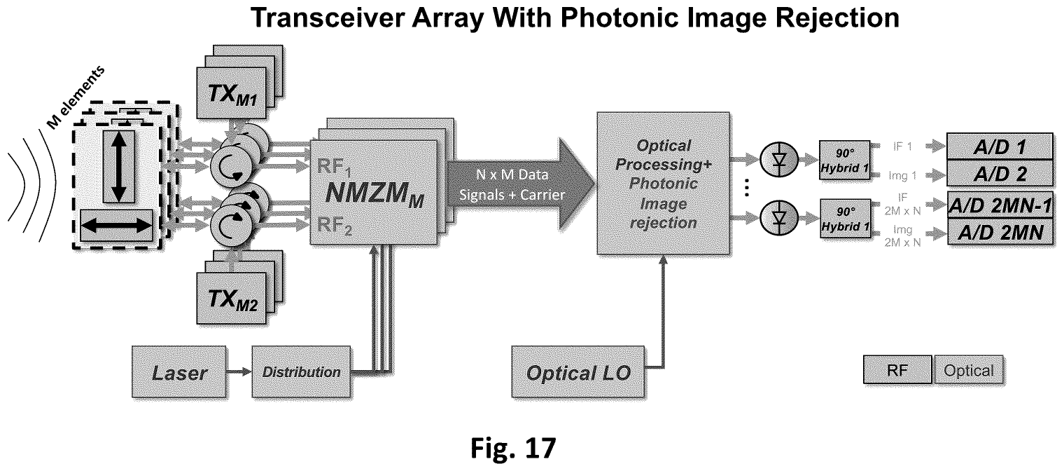

This transceiver architecture may also include a photonic image rejection device (as shown in FIGS. 16 and 17) described in U.S. Provisional Patent Application No. 63/165,276, filed Mar. 24, 2021, and U.S. patent application Ser. No, 17/703,916, each of which is hereby incorporated by reference in its entirety. The photonic image rejection method helps to reject anomalous RF signals that may be received by the antenna, which may include the transmitted signal if the transmitter and receiver use different frequency bands. If the transmitter and receiver use different frequency bands and orthogonal polarizations, the photonic image rejection technique would increase the rejection of transmitter signal in the receiver signal path. In this case the receiver would get rejection benefits from the NMZM, photonic image rejection, circulator/duplexer/diplexer, and digitally subtracting the sampled unwanted signal present on the unwanted polarization and/or unwanted frequency. This transceiver could also be configured in an array as shown in FIG. 17. This transceiver array could be used for multi-beam transmit/receive with optical processing of received signals, such as beam-space processing.

The polarization-diverse radio receive element disclosed here may include one or more advantages. In the simplest case where the antenna or antennas of this receiver element are detecting a circularly polarized signal, both USB and LSB outputs can be used. One sideband may be used to send the signal through the entire receiver chain to down-convert and digitize the data, while the other may be used to monitor the incoming signal and capture additional information that may be useful for system enhancements such as for calibration and/or for polarization tracking. The outputs could additionally be compared to receive information for calibration and/or polarization tracking. The electrical signals output by the photodiodes can be used to gain information about the polarization state of the incoming RF signal(s). In another operational mode, the device may simultaneously receive and demultiplex two data streams encoded on orthogonal circular polarizations, or orthogonal linear polarizations.

All the use cases and output conditions described above are achievable with proper bias conditions although a real physical implementation may require adjustment of the actual bias conditions (which may include amplitude and phase balancing) due to, e.g., fabrication tolerances. Additionally, RF phase shifters may be introduced in various places in the signal path to compensate for phase error present in devices or due to fabrication tolerances.

Terms such as “the same” or phrases such as “maintained to be the same” are intended to include minor variations that do not otherwise affect the operation of the system. The term “substantial” or “substantially” may be used to reflect this meaning.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

The following publications also are incorporated by reference in their entirety and provide details of systems and methods in which this invention may also be implemented:

Dillon, Thomas E., et al. “Passive millimeter wave imaging using a distributed aperture and optical upconversion.” Millimetre Wave and Terahertz Sensors and Technology III. Vol. 7837. International Society for Optics and Photonics, 2010.

C. A. Schuetz, J. Murakowski, G. J. Schneider and D. W. Prather, “Radiometric Millimeter-wave detection via optical upconversion and carrier suppression,” in IEEE Transactions on Microwave Theory and Techniques, vol. 53. no. 5. pp. 1732-1738. May 2005. doi: 10.1109/TMTT.2005.847106.

What is claimed is:

1. An apparatus for receiving radio signals of diverse polarization, the apparatus comprising:
a coherent light source configured to output an optical carrier signal;
a dual polarization antenna configured to receive an RF signal and output a first RF electrical signal based on a first polarization mode of the RF signal and a second RF electrical signal based on a second polarization mode of the RF signal that is orthogonal to the first polarization mode; and
a nested Mach-Zehnder Modulator configured to receive the optical carrier signal, the first RF electrical signal corresponding to a first polarization mode and the second RF electrical signal corresponding to a second polarization mode that is orthogonal to the first polarization mode, modulate the optical carrier signal based on the first RF electrical signal and the second RF electrical signal to generate an upper optical sideband signal, a lower optical sideband signal, and output the optical carrier signal, an upper sideband optical sideband signal, and the lower optical sideband signal, wherein the optical carrier signal, the lower optical sideband signal, and the upper optical sideband signal are output separately.

2. The apparatus of claim 1, further comprising a first photodetector configured to convert the optical sideband signal into an electrical signal.

3. The apparatus of claim 1, wherein the nested Mach-Zehnder modulator comprises:
an input optical coupler configured to split the optical carrier signal into a first optical carrier signal and a second optical carrier signal;
a first inner Mach-Zehnder modulator configured to receive the first optical carrier signal and a first RF electrical signal from a dual-polarization antenna, split the first optical carrier signal into a first internal light signal and a second internal light signal, modulate at least one of the first and second internal light signals based on the first RF electrical signal, selectively shift the relative phase between the first internal light signal and the second internal light signal, combine the first internal light signal and the second internal light signal after modulating at least one of the first and second optical carrier signals to produce a first sideband light signal, and output the first sideband light signal;
a second inner Mach-Zehnder modulator configured to receive the second optical carrier signal and a second RF electrical signal, split the second optical carrier signal into a third internal light signal and a fourth internal light signal, modulate at least one of the third and fourth internal light signals based on the second RF electrical signal, selectively shift the relative phase between the third internal light signal and the fourth internal light signal, combine the third internal light signal and the fourth internal light signal after modulating at least one of the third and fourth internal light signal to produce a second sideband light signal, and output the second sideband light signal;
an optical phase shifter configured to shift the relative phase between the first sideband light signal and the second sideband light signal; and
an output optical coupler configured to combine the first sideband light signal and the second sideband light signal to generate a combined optical sideband signal and output the combined optical sideband signal.

4. The apparatus of claim 1, further comprising an optical filter configured to filter the optical sideband signal to remove a portion of the optical sideband signal.

5. The apparatus of claim 4, further comprising an optical local oscillator for heterodyning the optical sideband signal.

6. The apparatus of claim 1, further comprising an RF transmitter electrically connected to the first output of the dual polarization antenna and the second output of the dual polarization antenna.

7. The apparatus of claim 1, further comprising a photonic image rejection photonic circuit configured to receive the optical sideband signal.

8. The apparatus of claim 1, wherein at least one photodetector is located remotely from the nested Mach-Zehnder modulator and is optically connected to the nested Mach-Zehnder modulator by an optical fiber.

9. The apparatus of claim 1, wherein the first polarization mode is a linear polarization mode, and the second polarization mode is a linear polarization mode orthogonal to the first polarization mode.

10. The apparatus of claim 1, wherein the first polarization mode is a right-handed circular polarization mode, and the second polarization mode is a left-handed circular polarization mode.

11. The apparatus of claim 6, further comprising a circulator configured to cause a transmission signal to have circular polarization.

12. The apparatus of claim 1, wherein no RF phase shifters are employed between the dual polarization antenna and the nested Mach-Zehnder modulator.

13. A system for receiving radio signals of diverse polarization, the system comprising:
a plurality of dual polarization antennas arranged in an array; and
a plurality of apparatuses according to claim 1 with each dual polarization antenna electrically connected to a corresponding apparatus of the plurality of apparatuses.

14. The system of claim 13, further comprising:
an optical local oscillator configured to heterodyne at least one of the upper optical sideband or the lower optical sideband.

15. The system of claim 13, further comprising:
an optical processing unit connected to the plurality of apparatuses and the optical local oscillator.

16. A method for receiving radio signals of diverse polarization, comprising:
receiving two orthogonal components of an RF signal having a 90-degree phase difference directly from a dual-polarization antenna without any intervening RF phase shifters;
modulating an optical carrier signal with the two orthogonal components of the RF signal to produce a first modulated light signal corresponding to a first orthogonal component of the RF signal and a second modulated light signal corresponding to the second orthogonal component of the RF signal;
combining the first modulated light signal and the second modulated light signal to produce an upper sideband light signal corresponding to the RF signal and a lower sideband light signal corresponding to the RF signal; and
outputting the upper sideband light signal corresponding to the RF signal to a first port and the lower sideband light signal corresponding to the RF signal to a second port.

17. The method of claim 16, further comprising heterodyning at least one of the lower sideband light signal or the upper sideband light signal with the optical carrier signal.

18. The method of claim 17, further comprising outputting a heterodyned lower sideband light signal or a heterodyned upper sideband light signal to a photodetector to produce an RF signal.

19. The method of claim 16, wherein modulating the optical carrier signal comprises:
splitting the optical carrier signal into a first optical carrier signal and a second optical carrier signal;
modulating the first optical carrier signal with a first orthogonal component of the RF signal to produce a first sideband light signal;
modulating the second optical carrier signal with the second orthogonal component of the RF signal to produce a second sideband light signal; and
combining the first sideband light signal and the second sideband light signal to produce the modulated light signal.

20. The method of claim 19, wherein modulating the optical carrier signal further comprises:
shifting the relative phase of the first sideband light signal and the second sideband light signal to bias an upper sideband at a first output port and a lower sideband at a second output port.

21. The method of claim 20, wherein the RF signal is a first RF signal, the method further comprising:
receiving two orthogonal components of a second RF signal having a 90-degree phase difference directly from the dual-polarization antenna without any intervening RF phase shifters simultaneously with receiving the first RF signal;
modulating the optical carrier signal with the two orthogonal components of the second RF signal such that the first modulated light signal additionally corresponds to a first orthogonal component of the second RF signal and the second modulated light signal additionally corresponds to a second orthogonal component of the second RF signal;
wherein combining the first modulated light signal and the second modulated light signal produces an upper sideband light signal corresponding to the second RF signal and a lower sideband light signal corresponding to the second RF signal; and
outputting the lower sideband light signal corresponding to the second RF signal to the first port and the upper sideband light signal corresponding to the second RF signal to the second port.

22. The method of claim 21, wherein shifting the relative phase of the first sideband light signal and the second sideband light signal biases an upper sideband corresponding to the first RF signal and a lower sideband corresponding to the second RF signal at a first output port and an upper sideband corresponding to the second RF signal and a lower sideband corresponding to the first RF signal at a second output port.
